(19) United States
(12) Patent Application Publication
(10) Pub. No.: US 2006/0195398 A1
(43) Pub. Date: Aug. 31, 2006

(54) Method and apparatus for processing payment requests

(76) Inventors: Sanjeev Dheer, Scarsdale, NY (US); Gautam Sinha, San Ramon, CA (US); Scott Strug, White Plains, NY (US); Jeremy N. Sokolic, New York, NY (US)

Correspondence Address: LEE & HAYES, PLLC, 421 W. RIVERSIDE AVE, STE 500, SPOKANE, WA, 99201, US

(21) Appl. No.: 11/348,535

(22) Filed: Feb. 6, 2006

Related U.S. Application Data
(60) Provisional application No. 60/650,263, filed on Feb. 4, 2005.

(51) Int. Cl. G06Q 40/00

(52) U.S. Cl. 705/40

(57) ABSTRACT

A request is received from a user to register to use a payment system. Further received is identification of a user bank account to which received payments are to be deposited. An email address is also received along with an amount from the user. A request for payment is generated having the associated amount. The request for payment is then sent to the email address. The email recipient is offered multiple options for making an electronic payment. The email recipient's electronic payment choice is received and the electronic payment is processed on behalf of the user.

### RELATED APPLICATIONS

This application claims the benefit of U.S. Provisional Application No. 60/650,263, filed Feb. 4, 2005, the disclosure of which is incorporated by reference herein.

### TECHNICAL FIELD

The present invention relates to processing payment requests and, more particularly, to a system that allows any individual or entity to make a payment to any other individual or entity.

### BACKGROUND

Many situations occur in which an individual requests payment from a third party (e.g., another individual, a business, or other entity) for various formal or informal transactions. For example, an individual may request payment from a friend for their portion of a dinner bill or other purchase. Individuals may request payments in the form of a contribution to a church, school, or charity. Similarly, small businesses often send invoices for products or services to their customers. Typically, these invoices are sent to customers as printed bills.

Payment transactions are typically conducted via cash, check, money order, or credit card. However, credit card payments are not typically possible for payments to individuals. For example, an individual cannot generally accept payment for dinner from a friend via a credit card. For an entity to be qualified to accept credit cards, the entity generally must be a qualified business with certain minimum economic characteristics (e.g., revenue, profit, and the like).

Payment via cash, check, or money order require the payment recipient to deposit the cash, check, or money order in an account at their bank (or cash the check or money order at their bank). The physical process of depositing a check introduces a delay into the posting of the deposit. Further, with this type of transaction, there is no automatic record-keeping of the transaction. The payment recipient must manually record such payments if they wish to maintain records of these types of transactions.

### BRIEF DESCRIPTION OF THE DRAWINGS

FIG. 1 illustrates an example environment in which the systems and methods described herein can be implemented.

FIG. 2 is a block diagram showing pertinent components of an example computer system.

FIG. 3 is a flow diagram illustrating an example procedure for registering with a payment system.

FIG. 4 is a flow diagram illustrating an example procedure for generating a payment request.

FIG. 5 is a flow diagram illustrating an example procedure for responding to a payment request.

### DETAILED DESCRIPTION

The systems and methods described herein automate the payment process between two individuals and/or entities. In a described implementation, the payment process is handled via the Internet. The automated payment systems and processes described herein have several advantages over the traditional physical model discussed above. The automated system reduces the time, cost, and effort of requesting a payment from an individual or entity. The automated system eliminates the need for paper invoices, and removes the delays associated with posting requests for payment, waiting to receive the payment, depositing the payment, and manually creating records of the transaction.

The systems and methods described herein also enable all individuals to act as if they were merchants and receive payments via credit card that they would not be able to do using the physical model discussed above. As described herein, payments are automatically deposited into the payee's bank account, thereby reducing the time and cost of receiving a physical check or cash, and then depositing the check or cash in the bank. Further, the automated record keeping allows the individual or entity to maintain accurate transaction records without having to manually record each transaction. Since transaction records are maintained automatically, the user can easily manage accounts receivable information and monitor other transaction information.

In a particular embodiment, the transactions discussed herein are conducted via the Internet. In alternate embodiments, other networks or data communication links are used instead of, or in addition to, the Internet to implement the transactions described herein. Additionally, the systems and methods described herein can be implemented as a stand-alone service offered to any user, or implemented by a specific financial institution (or other entity) for the benefit of their clients or customers.

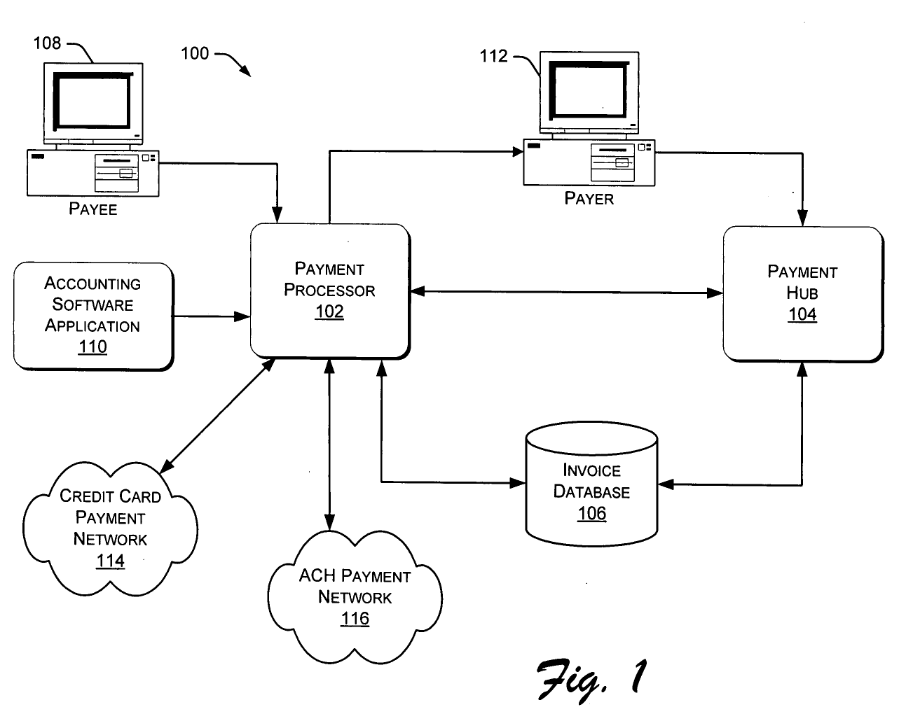

FIG. 1 illustrates an example environment 100 in which the systems and methods described herein can be implemented. A payment processor 102 handles various functions, such as registering payees, generating payment requests, maintaining records of payment requests and received payments, and processing payments through an appropriate payment network. In a particular embodiment, payment processor 102 is a server or similar computing device. Payment processor 102 is coupled to a payment hub 104, which receives payment information from a payment originator (e.g., a payer) and communicates that information to payment processor 102 and/or an invoice database 106. Invoice database 106 stores information regarding payment requests and payment transactions. In a particular embodiment, payment hub 104 is a computing device, such as a server. In an alternate embodiment, the functionality of payment hub 104 is incorporated into payment processor 102.

Payment processor 102 is also coupled to one or more computer systems associated with one or more payees 108. Payment processor 102 receives registration information and payment requests from payees 108. Additionally, payment processor 102 communicates payment transaction status information to payee 108. An accounting software application 110 is also coupled to payment processor 102. Accounting software application 110 can generate payment requests and record the status and results of the payment requests. Accounting software application 110 may be a separate application as shown in FIG. 1, or may be contained within one or more computer systems associated with one or more payees 108.

Payment processor 102 and payment hub 104 are also coupled to one or more computer systems associated with one or more payers 112 (e.g., payment originators). Payment processor 102 provides payment request information to payers 112 (e.g., in the form of an email message). Payers 112 respond to the payment request (e.g., by accessing a web page link embedded in an email message). The response of payers 112 is provided to payment hub 104, which provides the response to payment processor 102. Payment processor 102 processes credit card or debit card transactions via a credit card payment network 114. Payment processor 102 processes debits from bank accounts using ACH payment network 116. Alternate embodiments may include other types of payment networks not shown in FIG. 1. Additional details regarding processing payment transactions are provided below.

In one embodiment, some or all of the communications between components and devices shown in FIG. 1 are performed via the Internet. For example, payment processor 102 may communicate with payment hub 104, invoice database 106, payee 108, and payer 112 via the Internet.

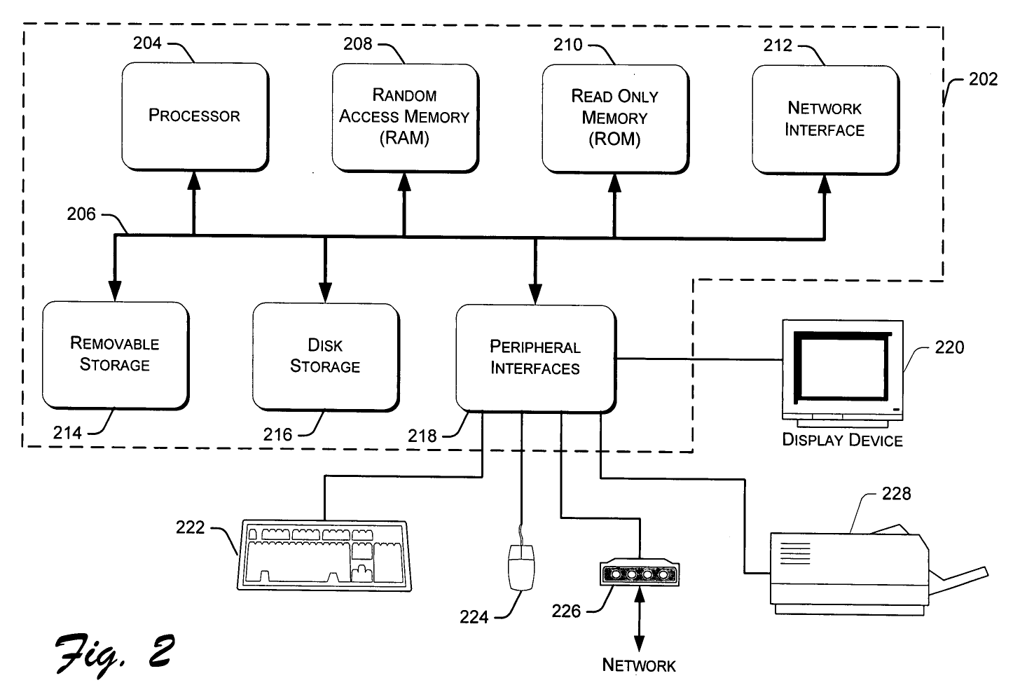

FIG. 2 is a block diagram showing pertinent components of an example computer system 202. A computer such as that shown in FIG. 2 can be used, for example, as payment processor 102 and/or payment hub 104. The computer shown in FIG. 2 can function as a server, a client computer, a payee computer, or a payer computer, of the types discussed herein.

Computer 202 includes at least one processor 204 coupled to a bus 206 that couples together various system components. Bus 206 represents one or more of any of several types of bus structures, such as a memory bus or memory controller, a peripheral bus, and a processor or local bus using any of a variety of bus architectures. A random access memory (RAM) 208 and a read only memory (ROM) 210 are coupled to bus 206. Additionally, a network interface 212 and a removable storage device 214, such as a floppy disk or a CD-ROM, are coupled to bus 206. Network interface 212 provides an interface to a data communication network such as a local area network (LAN) or a wide area network (WAN) for exchanging data with other computers and devices. A disk storage 216, such as a hard disk, is coupled to bus 206 and provides for the non-volatile storage of data (e.g., computer-readable instructions, data structures, program modules, and other data used by computer 202). Although computer 202 illustrates a removable storage 214 and a disk storage 216, it will be appreciated that other types of computer-readable media which can store data that is accessible by a computer, such as magnetic cassettes, flash memory cards, digital video disks, and the like, may also be used in the example computer.

Various peripheral interfaces 218 are coupled to bus 206 and provide an interface between the computer 202 and various individual peripheral devices. Example peripheral devices include a display device 220, a keyboard 222, a mouse 224, a modem 226, and a printer 228. Modem 226 can be used to access other computer systems and devices directly or by connecting to a data communication network such as the Internet.

A variety of program modules can be stored on the disk storage 216, removable storage 214, RAM 208, or ROM 210, including an operating system, one or more application programs, and other program modules and program data. A user can enter commands and other information into computer 202 using the keyboard 222, mouse 224, or other input devices (not shown). Other input devices may include a microphone, joystick, game pad, scanner, satellite dish, or the like.

Computer 202 may operate in a network environment using logical connections to other remote computers. The remote computers may be personal computers, servers, routers, or peer devices. In a networked environment, some or all of the program modules executed by computer 202 may be retrieved from another computing device coupled to the network.

Typically, the computer 202 is programmed using instructions stored at different times in the various computer-readable media of the computer. Programs and operating systems are often distributed, for example, on floppy disks or CD-ROMs. The programs are installed from the distribution media into a storage device within the computer 202. When a program is executed, the program is at least partially loaded into the computer's primary electronic memory. As described herein, the invention includes these and other types of computer-readable media when the media contains instructions or programs for implementing the steps described below in conjunction with a processor. The invention also includes the computer itself when programmed according to the procedures and techniques described herein.

For purposes of illustration, programs and other executable program components are illustrated herein as discrete blocks, although it is understood that such programs and components reside at various times in different storage components of the computer, and are executed by the computer's processor. Alternatively, the systems and procedures described herein can be implemented in hardware or a combination of hardware, software, and/or firmware. For example, one or more application specific integrated circuits (ASICs) can be programmed to carry out the systems and procedures described herein.

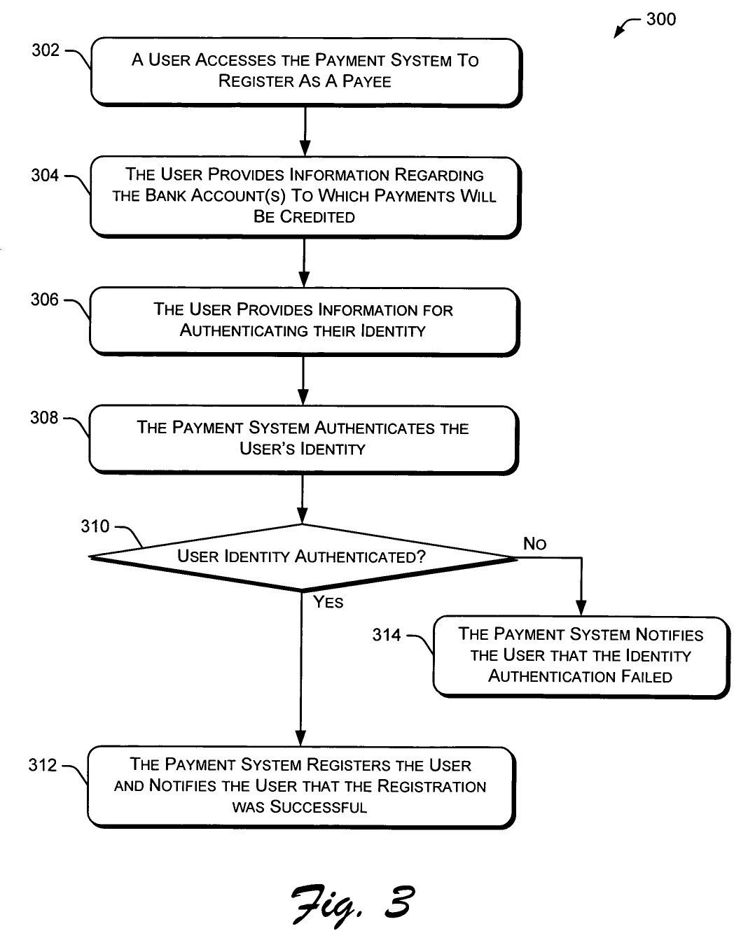

FIG. 3 is a flow diagram illustrating an example procedure 300 for registering with a payment system. Initially, a user accesses the payment system (e.g., payment processor 102) to register as a payee (block 302). The user provides information regarding one or more bank accounts to which payments will be credited (block 304). The user also provides information for authenticating their identity (block 306). This information may include their social security number, drivers license number, or similar information. The payment system then authenticates the user's identity (block 308). The process may involve accessing external databases and retrieving relevant information (e.g., in the form of challenge questions) to validate the identity of the user and the ownership of the account. If the user's identity is authenticated, the payment system registers the user and notifies the user (e.g., via email) that the user registration was successful (block 312). Once the registration of the user is complete, the user can access the payment system at any time to initiate a request for payment. If the user's identity is not authenticated at block 310, the payment system does not register the user and, instead, notifies the user that the identity authentication failed (block 314).

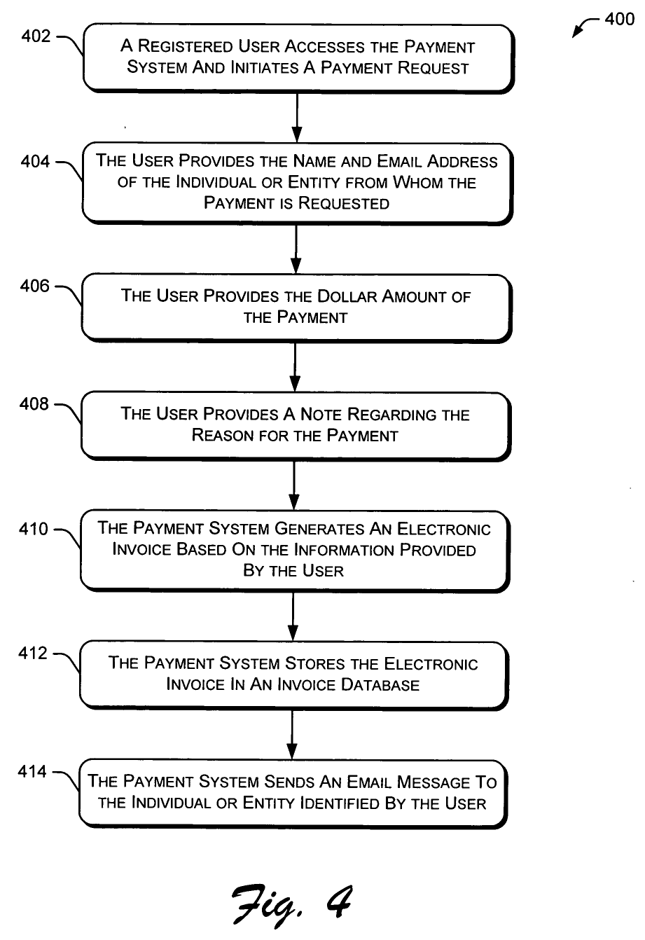

FIG. 4 is a flow diagram illustrating an example procedure 400 for generating a payment request. Initially, a registered user accesses the payment system and initiates a payment request (block 402). The user then provides the name and email address of the individual or entity from whom the payment is requested (block 404). In certain situations, a user may provide multiple names and email addresses to generate multiple payment requests simultaneously. The multiple payment requests may have the same or different payment amounts.

Procedure 400 continues as the user provides the dollar amount of the payment (block 406). The user then provides a note regarding the reason for the payment (block 408). Such a note might state “Your portion of dinner last Friday”, “Your portion of the February rent”, or “Your annual membership dues”. Next, the payment system generates an electronic invoice based on the information provided by the user (block 410). The payment system stores the electronic invoice in an invoice database (block 412). The payment system then sends an email message to the individual or entity identified by the user (block 414).

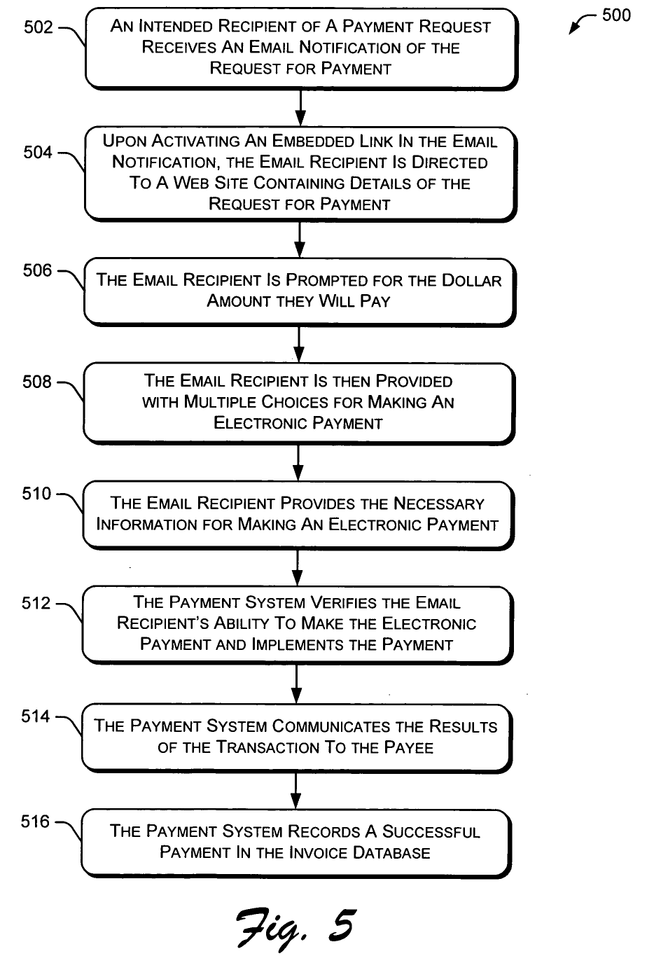

FIG. 5 is a flow diagram illustrating an example procedure 500 for responding to a payment request. Initially, an intended recipient of a payment request receives an email notification of the request for payment (block 502). For example, the email notification may be generated and sent by payment processor 102. The email notification includes an embedded link (or other instruction) that directs the email recipient to a web site that allows them to make a payment. Upon activating the embedded link in the email notification, the email recipient is directed to a web site containing details of the request for payment (block 504). These details include, for example, the payee requesting the payment, the payment amount, and a note indicating the reason for requesting the payment.

The email recipient is then prompted for the dollar amount they will pay (block 506). This dollar amount may be the same or different from the amount contained in the payment request. The email recipient is then provided with multiple choices for making an electronic payment (block 508). These choices may include, for example, paying by credit card, debit card, or by a direct debit to their bank account (e.g., checking account or savings account). The email recipient selects one of the payment choices (e.g., based on the method most convenient to the email recipient) and provides the necessary information for making the selected payment (block 510). For example, if the email recipient selects a direct debit to their bank account, they will be asked for their bank account number and the ABA routing number associated with the account. If the email recipient selects a credit card or debit card, they will be asked for the credit card number or the debit card number. In a particular embodiment, the email recipient may also select to print a copy of the payment request and mail a payment to the payee.

The payment system verifies the email recipient's ability to make the electronic payment and, if verified, implements the payment (block 512). The type of verification depends on the type of payment option chosen by the payee or the payer. For example, if the payment option chosen is to pay via a debit to the payer's checking account, then the processor verifies that the payer owns the account they are using for the payment.

The payment system then communicates the results of the transaction to the payee (block 514). Additionally, the payment system records a successful payment of the payment request in the invoice database (block 516).

When processing the payment of the payer, the payment is handled in two steps. If payment is made by debiting a bank account, the process first debits the payer's bank account and credits the debited amount to an intermediate account (also referred to as a “clearing account” or “central clearing account”). Second, the process debits the intermediate account (by the same amount as in the first step) and credits the payee's bank account. The entity responsible for the intermediate account may be referred to as a “third party processor”.

Similarly, if payment is made by charging a credit card (or debit card), the third party processor first charges the payer's credit card account and credits the charged amount to an intermediate account. In this example, the third party processor is a business or merchant capable of accepting various credit card and/or debit card transactions. Second, the process credits the payee's bank account by the same amount as the charge in the first step (less any fees charged by the third party processor). Thus, an individual payee is able to receive payments from payers via credit card or debit card without requiring the individual payee to have a business.

Both the payee and the payer are capable of accessing transaction information from the invoice database. This allows each party to obtain a real-time status of the transaction, but keeps the confidential payment information provided by the payer from the payee.

The systems and methods described herein may charge and subtract fees to or from the payee and/or the payer. The fees may vary depending on the size of the payment, the frequency with which the user requests or makes payments using the service, the speed with which the payment must be completed, or the type of payment method chosen by the payee. Fees may be paid by the payee or the payer. In certain situations, fees may be split between the payee and the payer. For example, if a payer is late in paying a payee, the payer may pay an expedited payment fee so that the payee is paid faster, while the payee pays the standard transaction processing fee.

The systems and methods described herein provide a single point of contact for verification of multiple types of accounts. For example, a third party processor is capable of verifying credit card accounts, debit card accounts, and bank accounts. The third party processor is capable of providing a single statement to the payee for all types of transactions (e.g., credit card transactions, debit card transactions, and bank account transactions). This single statement can also identify all fees associated with the different types of transactions.

Although the description above uses language that is specific to structural features and/or methodological acts, it is to be understood that the invention defined in the appended claims is not limited to the specific features or acts described. Rather, the specific features and acts are disclosed as example forms of implementing the invention.

1. A method comprising:
receiving a request from a user to register to use a payment system;
receiving identification of a user bank account to which received payments are to be deposited;
receiving an email address and an amount from the user;
generating a request for payment having the associated amount;
sending the request for payment to the email address;
offering the email recipient a plurality of options for making an electronic payment;
receiving the email recipient's electronic payment choice; and
processing the chosen electronic payment on behalf of the user.

2. A method as recited in claim 1 wherein the user is an individual that is not qualified to initiate electronic payments with other individuals.

3. A method as recited in claim 1 wherein the electronic payment is processed through an ACH network.

4. A method as recited in claim 1 wherein the electronic payment is a credit card payment.

5. A method as recited in claim 1 wherein receiving a request from a user to register to use a payment system includes authenticating the identity of the user.

6. A method as recited in claim 1 further comprising authenticating the identity of the user and validating the user's ability to accept different types of electronic payments.

7. A method as recited in claim 1 further comprising verifying the ability of the of the email recipient to make the selected electronic payment choice.

8. A method as recited in claim 1 further comprising receiving the email recipient's electronic payment information after receiving the email recipient's electronic payment choice.

9. A method as recited in claim 8 wherein the email recipient's electronic payment information is kept confidential from the user.

10. A method as recited in claim 1 wherein processing the electronic payment on behalf of the user includes:
processing a first transaction based on the email recipient's electronic payment choice;
transferring funds from the email recipient's account to a central account owned by a third party processor; and
processing a second transaction that includes debiting the central account owned by the third party processor and crediting the account owned by the user.

11. A method as recited in claim 1 further comprising:
notifying the email recipient of a status of the electronic payment; and
notifying the user of the status of the electronic payment.

12. A method as recited in claim 1 further comprising collecting fees from the user based on the electronic payment.

13. A method comprising:
receiving instructions from an individual user to initiate a payment request, wherein the payment request includes an associated email address and amount;
generating the payment request with the associated amount;
sending the request for payment to the associated email address, wherein the user is not directly entitled to make an electronic debit to a bank account of another person;
offering the email recipient a plurality of options for making an electronic payment, wherein the options for making an electronic payment include a direct debit to a bank account;
receiving the email recipient's electronic payment choice;
validating the email recipient's ownership of their bank account;
a third party processor debiting the email recipient's bank account;
crediting a third party processor's central clearing account; and
the third party processor crediting the user's account with the amount of the payment request.

14. A method as recited in claim 13 where the email recipient can agree to payment to subsequent requests from the user and the third party processor processes subsequent payments without requiting any additional information from the email recipient.

15. A method as recited in claim 13 wherein the individual user is not qualified to initiate electronic payments with other individuals.

16. A method as recited in claim 13 in which the user initiates payment to multiple recipients.

17. A method as recited in claim 13 further comprising authenticating the identity of the user before sending the request for payment.

18. A method as recited in claim 13 wherein receiving the email recipient's electronic payment choice includes receiving the email recipient's electronic payment information.

19. A method as recited in claim 18 further comprising maintaining the email recipient's electronic payment information confidential from the user.

20. A method as recited in claim 13 further comprising collecting fees from the user for processing the payment request.

21. One or more computer-readable media having stored thereon a computer program that, when executed by one or more processors, causes the one or more processors to:
receiving a request from a user to register to use a payment system;
receiving identification of a user bank account to which received payments are to be deposited;
receiving an email address and an amount from the user;
sending a request for payment to the email address, wherein the request includes the amount;
offering the email recipient a plurality of options for making an electronic payment;
receiving the email recipient's electronic payment choice;
receiving the email recipient's electronic payment amount; and
processing the chosen electronic payment and payment amount on behalf of the user.

22. One or more computer-readable media as recited in claim 21 wherein the one or more processors further update an invoice database upon completing the chosen electronic payment.
